(19) United States
(12) Patent Application Publication
(10) Pub. No.: US 2026/0226927 A1
(43) Pub. Date: Aug. 6, 2026

(54) WORK MACHINE

(71) Applicant: KOMATSU LTD., Tokyo (JP)

(72) Inventor: Yousuke Kotake, Tokyo (JP)

(73) Assignee: KOMATSU LTD., Tokyo (JP)

(21) Appl. No.: 19/150,930

(22) PCT Filed: Dec. 19, 2023
(86) PCT No.: PCT/JP2023/045549

§ 371 Date: Jul. 25, 2025

(30) Foreign Application Priority Data
Feb. 9, 2023 (JP) 2023-018530

(51) Int. Cl. E02F 9/22; E02F 3/43

(52) U.S. Cl. CPC F15B 21/14; E02F 3/435; E02F 9/2217; E02F 9/2271; E02F 9/2296; F15B 11/024; F15B 11/17; F15B 2211/20546; F15B 2211/20576; F15B 2211/212; F15B 2211/6346; F15B 2211/7053; F15B 2211/7135; F15B 2211/761; F15B 2211/88

(57) ABSTRACT

A work machine includes: a boom; a cylinder including a bottom chamber and a head chamber; a pump including a suction port and a discharge port; a hydraulic oil tank; an operation valve including a pump port connected to the discharge port, a bottom port connected to the bottom chamber, a head port connected to the head chamber, a tank port connected to the hydraulic oil tank, and a regenerative port connected to the suction port via a regenerative line; an accumulator connected to the regenerative line via an accumulator line; a switching valve that adjusts a flow rate of hydraulic oil in the accumulator line; and a controller that controls the boom operation valve and the switching valve so that hydraulic oil emitted from the bottom chamber is distributed to each of the suction port and the accumulator in a lowering operation of the boom.

### TECHNICAL FIELD

The present disclosure relates to a work machine.

### BACKGROUND ART

In a technical field related to a work machine, a hydraulic drive system for a construction machine as disclosed in Patent Document 1 is known.

### CITATION LIST

### Patent Document

Patent Document 1: JP 2019-052702 A

### SUMMARY OF INVENTION

### Technical Problem

In Patent Document 1, hydraulic oil emitted from a boom cylinder in a lowering operation of a boom is supplied to an accumulator via a regenerative valve, a first pump, and an accumulator switching valve. In Patent Document 1, hydraulic oil for pressurizing the accumulator passes through the first pump, and there is a possibility that the accumulator is not efficiently pressurized.

An object of the present disclosure is to efficiently pressurize an accumulator with hydraulic oil emitted from a boom cylinder in a lowering operation of a boom.

### Solution to Problem

According to the present disclosure, there is provided a work machine including: a boom; a boom cylinder including a bottom chamber and a head chamber; a boom pump including a suction port and a discharge port; a hydraulic oil tank; a boom operation valve including a pump port connected to the discharge port via a pump line, a bottom port connected to the bottom chamber via a bottom line, a head port connected to the head chamber via a head line, a tank port connected to the hydraulic oil tank via a tank line, and a regenerative port connected to the suction port via a regenerative line; an accumulator connected to the regenerative line via an accumulator line; an accumulator switching valve that adjusts a flow rate of hydraulic oil in the accumulator line; and a controller that controls the boom operation valve and the accumulator switching valve so that hydraulic oil emitted from the bottom chamber is distributed to each of the suction port and the accumulator in a lowering operation of the boom.

### Advantageous Effects of Invention

According to the present disclosure, an accumulator is efficiently pressurized with hydraulic oil emitted from a boom cylinder in a lowering operation of a boom.

### BRIEF DESCRIPTION OF DRAWINGS

FIG. 1 is a perspective view illustrating a work machine according to an embodiment.

FIG. 2 is a view illustrating a hydraulic system of the work machine according to the embodiment.

FIG. 3 is a view illustrating the hydraulic system when causing a boom to perform a raising operation by hydraulic oil discharged from a boom pump according to the embodiment.

FIG. 4 is a view illustrating the hydraulic system when causing the boom according to the embodiment to perform a lowering operation.

FIG. 5 is a view schematically illustrating a boom cylinder according to the embodiment.

FIG. 6 is a view showing an example of correlation data according to the embodiment.

FIG. 7 is a view illustrating the hydraulic system when causing the boom to perform a raising operation by hydraulic oil released from an accumulator according to the embodiment.

### DESCRIPTION OF EMBODIMENTS

Hereinafter, an embodiment according to the present disclosure will be described with reference to the drawings, but the disclosure is not limited to the embodiment. Components of the embodiment described below can be combined as appropriate. There is a case where some components are not used.

### Work Machine

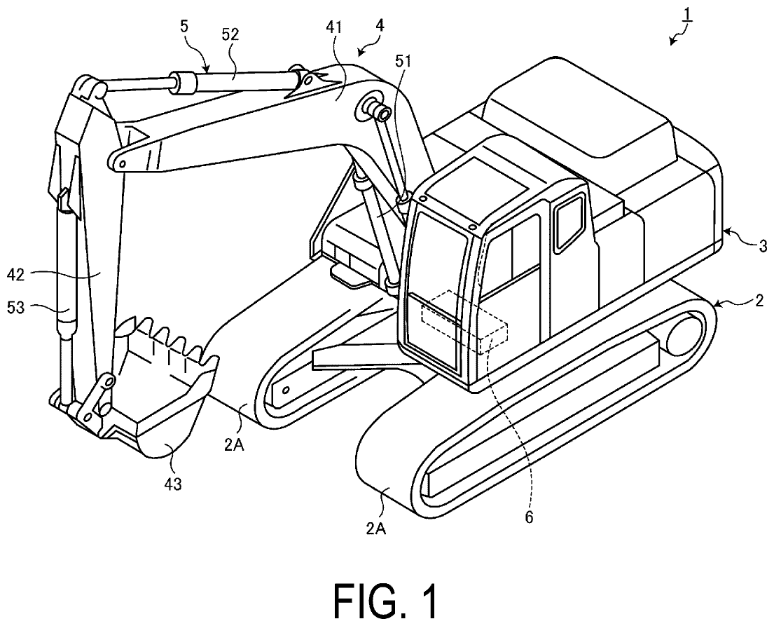

FIG. 1 is a perspective view illustrating a work machine 1 according to the embodiment. The work machine 1 operates at a work site. In the embodiment, the work machine 1 is a hydraulic excavator. In the following description, the work machine 1 is appropriately referred to as a hydraulic excavator 1. The hydraulic excavator 1 includes a traveling body 2, a revolving body 3, a work implement 4, a work implement cylinders 5, and a controller 6.

The traveling body 2 travels in a state of supporting the revolving body 3. The traveling body 2 includes a pair of the continuous tracks 2A. The continuous tracks 2A rotate by a traveling motor. By rotation of the continuous tracks 2A, the traveling body 2 travels. The revolving body 3 is supported by the traveling body 2. The revolving body 3 is provided with a cab. The work implement 4 is attached to the revolving body 3. The work implement 4 includes a boom 41, an arm 42, and a bucket 43. The work implement cylinder 5 operates the work implement 4. The work implement cylinder 5 is a hydraulic cylinder. The work implement cylinder 5 includes a boom cylinder 51, an arm cylinder 52, and a bucket cylinder 53. The controller 6 includes a computer system. The controller 6 controls the hydraulic excavator 1.

### Hydraulic System

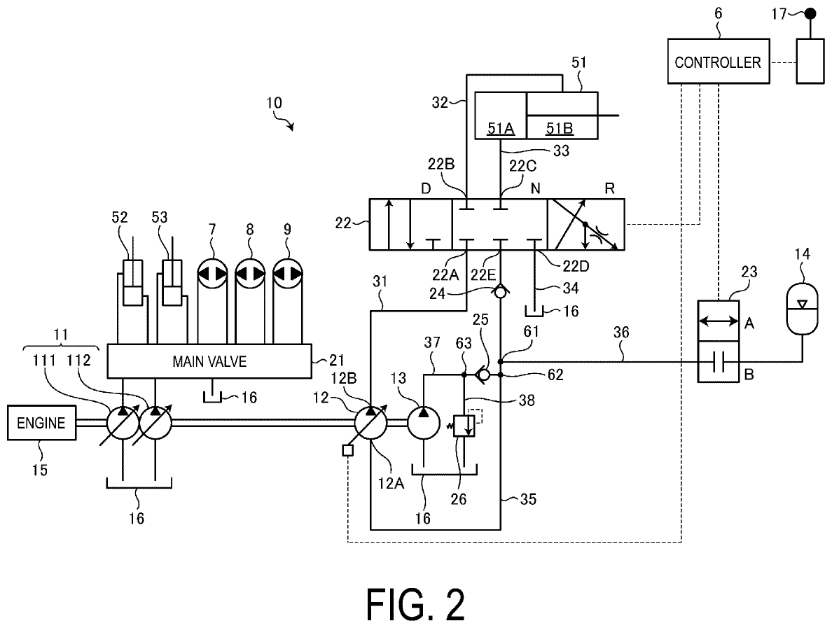

FIG. 2 is a view illustrating a hydraulic system 10 of the hydraulic excavator 1 according to the embodiment. The hydraulic system 10 includes an engine 15, a main hydraulic pump 11, a main valve 21, the arm cylinder 52, the bucket cylinder 53, a traveling motor 7, a traveling motor 8, a revolving motor 9, a boom pump 12, the boom cylinder 51, a boom operation valve 22, an accumulator 14, an accumulator switching valve 23, a hydraulic oil tank 16, an operation lever 17, and the controller 6.

The engine 15 is a power source of the hydraulic excavator 1. The engine 15 is connected (directly coupled) to each of the main hydraulic pump 11 and the boom pump 12. The engine 15 drives each of the main hydraulic pump 11 and the boom pump 12.

The main hydraulic pump 11 discharges hydraulic oil for actuating each of the arm cylinder 52, the bucket cylinder 53, the traveling motor 7, the traveling motor 8, and the revolving motor 9. The main hydraulic pump 11 is connected (directly coupled) to the boom pump 12. In the embodiment, two main hydraulic pumps 11 are provided. The main hydraulic pump 11 includes a main hydraulic pump 111 and a main hydraulic pump 112. Each of the main hydraulic pump 111 and the main hydraulic pump 112 is a variable capacity hydraulic pump whose pump capacity changes based on a swash plate angle. A suction port of the main hydraulic pump 11 is connected to the hydraulic oil tank 16. A discharge port of the main hydraulic pump 11 is connected to the main valve 21. The main hydraulic pump 11 sucks hydraulic oil in the hydraulic oil tank 16 from the discharge port and discharges the hydraulic oil from the discharge port to the main valve 21. Note that the number of the main hydraulic pumps 11 may be one or any number of three or more.

The main valve 21 controls the flow rate and the direction of hydraulic oil supplied from the main hydraulic pump 11 to the arm cylinder 52. The main valve 21 controls the flow rate and the direction of hydraulic oil supplied from the main hydraulic pump 11 to the bucket cylinder 53. The main valve 21 controls the flow rate and the direction of hydraulic oil supplied from the main hydraulic pump 11 to the traveling motor 7. The main valve 21 controls the flow rate and the direction of hydraulic oil supplied from the main hydraulic pump 11 to the traveling motor 8. The main valve 21 controls the flow rate and the direction of hydraulic oil supplied from the main hydraulic pump 11 to the revolving motor 9.

Each of the arm cylinder 52, the bucket cylinder 53, the traveling motor 7, the traveling motor 8, and the revolving motor 9 is a main hydraulic actuator different from the boom cylinder 51. The arm cylinder 52 is a hydraulic cylinder for causing the arm 42 to perform an excavation operation and a dumping operation. The bucket cylinder 53 is a hydraulic cylinder for causing the bucket 43 to perform an excavation operation and a dumping operation. The traveling motor 7 is a hydraulic motor for rotating the continuous track 2A on the left side. The traveling motor 8 is a hydraulic motor for rotating the continuous track 2A on the right side. The revolving motor 9 is a hydraulic motor for revolving the revolving body 3.

The boom pump 12 is a hydraulic pump that discharges hydraulic oil for actuating the boom cylinder 51. The boom pump 12 discharges hydraulic oil supplied to the boom cylinder 51. The boom pump 12 is a variable capacity hydraulic pump whose pump capacity changes based on a swash plate angle. The boom pump 12 includes a suction port 12A and a discharge port 12B. The boom pump 12 discharges, from the discharge port 12B, the hydraulic oil sucked from the suction port 12A. The suction port 12A of the boom pump 12 is not connected to the hydraulic oil tank 16. The boom pump 12 does not directly suck the hydraulic oil in the hydraulic oil tank 16. The hydraulic oil discharged from the discharge port 12B of the boom pump 12 is supplied to the boom cylinder 51 via the boom operation valve 22. The boom pump 12 is a hydraulic pump motor. The boom pump 12 can function as a hydraulic motor.

The boom cylinder 51 is a hydraulic cylinder for causing the boom 41 to perform a raising operation and a lowering operation. The boom cylinder 51 extends for causing the boom 41 to perform the raising operation. The boom cylinder 51 contracts in the lowering operation of the boom 41. The boom cylinder 51 includes a bottom chamber 51A and a head chamber 51B. When the hydraulic oil is supplied to the bottom chamber 51A and the hydraulic oil is emitted from the head chamber 51B, the boom cylinder 51 extends. When the hydraulic oil is supplied to the head chamber 51B and the hydraulic oil is emitted from the bottom chamber 51A, the boom cylinder 51 contracts.

The boom operation valve 22 controls the flow rate and the direction of hydraulic oil supplied from the boom pump 12 to the boom cylinder 51. The boom operation valve 22 supplies the bottom chamber 51A with the hydraulic oil discharged from the discharge port 12B of the boom pump 12 when causing the boom 41 to perform the raising operation. At least part of the hydraulic oil emitted from the bottom chamber 51A in the lowering operation of the boom 41 is returned to the suction port 12A of the boom pump 12 via the boom operation valve 22. However, when the pressure of the hydraulic oil emitted from the bottom chamber 51A is a set pressurization of the accumulator 14 or less by an action of a first check valve 24 described later, the hydraulic oil emitted from the bottom chamber 51A is emitted to the hydraulic oil tank 16.

The boom operation valve 22 includes a pump port 22A, a head port 22B, a bottom port 22C, a tank port 22D, and a regenerative port 22E. The pump port 22A is connected to the discharge port 12B of the boom pump 12 via a pump line 31. The head port 22B is connected to the head chamber 51B of the boom cylinder 51 via a head line 32. The bottom port 22C is connected to the bottom chamber 51A of the boom cylinder 51 via a bottom line 33. The tank port 22D is connected to the hydraulic oil tank 16 via a tank line 34. The regenerative port 22E is connected to the suction port 12A of the boom pump 12 via a regenerative line 35.

The boom operation valve 22 is movable to a raised position R, a neutral position N, and a lowered position D. The boom operation valve 22 moves based on a control command from the controller 6. When causing the boom 41 to perform a raising operation, the boom operation valve 22 is placed at the raised position R. When causing the boom 41 to perform a lowering operation, the boom operation valve 22 is placed at the lowered position D. When the boom 41 is stopped, the boom operation valve 22 is placed at the neutral position N. FIG. 2 illustrates a state in which the boom operation valve 22 is placed at the neutral position N.

The accumulator 14 is connected to the regenerative line 35 via an accumulator line 36. At least part of the hydraulic oil emitted from the bottom chamber 51A in the lowering operation of the boom 41 is supplied to the accumulator 14 via the accumulator line 36. The accumulator 14 is pressurized with the hydraulic oil supplied from the bottom chamber 51A. However, when the pressure of the hydraulic oil emitted from the bottom chamber 51A is a set pressurization of the accumulator 14 or less by an action of the first check valve 24 described later, the hydraulic oil emitted from the bottom chamber 51A is emitted to the hydraulic oil tank 16, and the accumulator 14 is not pressurized.

The accumulator line 36 is connected to a connection portion 61 of the regenerative line 35 between the regenerative port 22E and the suction port 12A. The first check valve 24 is disposed at the regenerative line 35 between the regenerative port 22E and the connection portion 61. The first check valve 24 permits the flow of the hydraulic oil from the regenerative port 22E to the connection portion 61 and blocks the flow of the hydraulic oil from the connection portion 61 to the regenerative port 22E.

The accumulator switching valve 23 adjusts the flow rate of the hydraulic oil in the accumulator line 36. The accumulator switching valve 23 is disposed at the accumulator line 36. The flow rate of the hydraulic oil at the accumulator line 36 is adjusted by adjusting the opening area of the accumulator switching valve 23.

The accumulator switching valve 23 is movable to a fully open position A and a fully closed position B. The accumulator switching valve 23 moves based on a control command from the controller 6. The controller 6 can adjust the opening area of the accumulator switching valve 23. When the accumulator switching valve 23 is placed at the fully open position A, the opening area of the accumulator switching valve 23 becomes 100%, and the hydraulic oil can flow through the accumulator line 36. By placing the accumulator switching valve 23 at the fully closed position B, the opening area of the accumulator switching valve 23 becomes 0%, and the hydraulic oil cannot flow through the accumulator line 36. FIG. 2 illustrates a state in which the accumulator switching valve 23 is placed at the fully closed position B.

The operation lever 17 is operated to actuate the boom operation valve 22. The operation lever 17 is disposed at the cab of the hydraulic excavator 1. The operation lever 17 is operated by an operator on board the cab of the hydraulic excavator 1. The operation lever 17 is operated to tilt. An operation signal generated by operating the operation lever 17 is transmitted to the controller 6.

The controller 6 controls the flow rate and the direction of hydraulic oil supplied to the boom cylinder 51 via the boom operation valve 22 based on an operation signal from the operation lever 17. The controller 6 adjusts the flow rate of the hydraulic oil supplied to the boom cylinder 51 based on the lever angle indicating the operation angle of the operation lever 17. The larger the lever angle is, the more the flow rate of the hydraulic oil supplied to the boom cylinder 51 becomes, and the higher the expansion/contraction speed of the boom cylinder 51 becomes. The smaller the lever angle is, the less the flow rate of the hydraulic oil supplied to the boom cylinder 51 becomes, and the lower the expansion/contraction speed of the boom cylinder 51 becomes.

In the embodiment, a charge pump 13 is connected (directly coupled) to the boom pump 12. A suction port of the charge pump 13 is connected to the hydraulic oil tank 16. A discharge port of the charge pump 13 is connected to a connection portion 62 of the regenerative line 35 via a charge line 37. The connection portion 62 is provided at the regenerative line 35 between the connection portion 61 and the suction port 12A.

A relief line 38 is connected to a connection portion 63 of the charge line 37. A relief valve 26 is disposed at the relief line 38. The charge pump 13 and the relief valve 26 are connected in parallel. A second check valve 25 is placed in a charge line 37 between the connection portion 63 and the connection portion 62. The second check valve 25 permits the flow of the hydraulic oil from the connection portion 63 to the connection portion 62 and blocks the flow of the hydraulic oil from the connection portion 62 to the connection portion 63.

### Raising Operation of Boom by Boom Pump

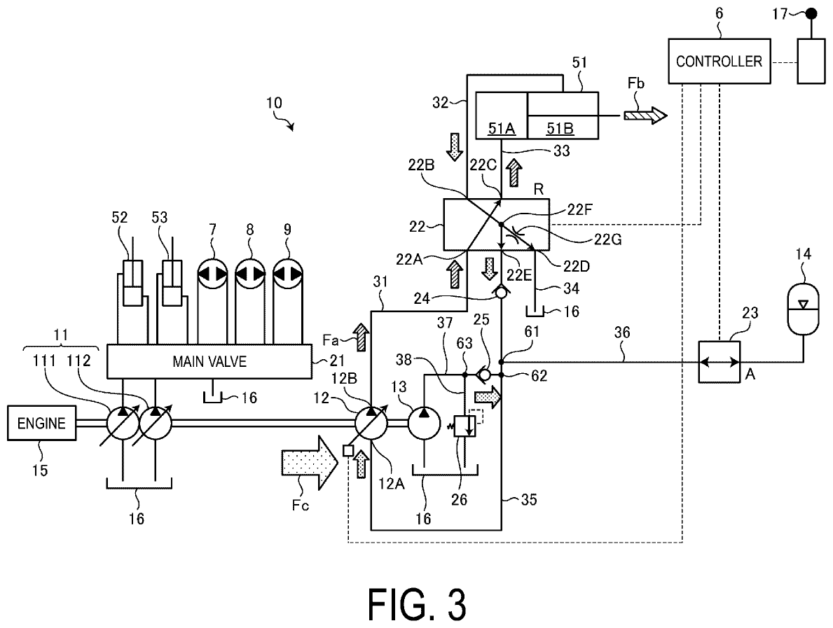

FIG. 3 is a view illustrating the hydraulic system 10 when causing the boom 41 to perform a raising operation by the hydraulic oil discharged from the boom pump 12 according to the embodiment. Note that in FIG. 3, arrow Fa indicates a direction in which the hydraulic oil flows, and arrow Fb indicates an expansion/contraction direction of the boom cylinder 51. The boom operation valve 22 illustrated in FIG. 3 is illustrated with a part of the boom operation valve 22 placed at the raised position R extracted, and the accumulator switching valve 23 illustrated in FIG. 3 is illustrated with a part of the accumulator switching valve 23 placed at the fully open position A extracted.

When the operation lever 17 is operated for the boom 41 to perform a raising operation, the controller 6 outputs a control command to the boom operation valve 22 so that the boom operation valve 22 is placed at the raised position R based on an operation signal from operation lever 17. When the boom 41 is caused to perform a raising operation, the controller 6 outputs a control command to the accumulator switching valve 23 so that the accumulator switching valve 23 is placed at the fully open position A.

The boom pump 12 is driven by a rotational force generated by the engine 15. As indicated by arrow Fc in FIG. 3, the rotational force generated by the engine 15 is transmitted to the boom pump 12 via the main hydraulic pump 11. When the rotational force of the engine 15 is transmitted to the boom pump 12, the boom pump 12 is driven. The boom pump 12 discharges, from the discharge port 12B, the hydraulic oil sucked from the suction port 12A. The hydraulic oil discharged from the discharge port 12B is supplied to the bottom chamber 51A of the boom cylinder 51 via the pump line 31, the pump port 22A of the boom operation valve 22, the bottom port 22C of the boom operation valve 22, and the bottom line 33. When the bottom chamber 51A is supplied with the hydraulic oil, the boom cylinder 51 extends, and the boom 41 performs a raising operation.

In the embodiment, the boom operation valve 22 includes a branch portion 22F that distributes the hydraulic oil from the head port 22B to the tank port 22D and the regenerative port 22E, and a throttle 22G disposed between the branch portion 22F and the tank port 22D. Part of the hydraulic oil emitted from the head chamber 51B is emitted to the hydraulic oil tank 16 via the head line 32, the head port 22B of the boom operation valve 22, the branch portion 22F of the boom operation valve 22, the tank port 22D of the boom operation valve 22, and the tank line 34. Part of the hydraulic oil emitted from the head chamber 51B is supplied to the suction port 12A of the boom pump 12 via the head line 32, the head port 22B of the boom operation valve 22, the branch portion 22F of the boom operation valve 22, the regenerative port 22E of the boom operation valve 22, and the regenerative line 35.

The charge pump 13 supplements the hydraulic oil supplied to the suction port 12A. The charge pump 13 supplies the hydraulic oil to the suction port 12A via the charge line 37, the connection portion 62, and a part of the regenerative line 35 so that the flow rate of the hydraulic oil discharged from the discharge port 12B matches the flow rate of the hydraulic oil flowing into the suction port 12A. The hydraulic oil is discharged from the charge pump 13 so that the flow rate of the hydraulic oil discharged from the discharge port 12B matches the flow rate of the hydraulic oil flowing into the suction port 12A, whereby the suction port 12A and the regenerative line 35 are suppressed from having negative pressure. Since the suction port 12A and the regenerative line 35 are suppressed from having negative pressure, cavitation is suppressed from being generated at the suction port 12A and the regenerative line 35.

### Lowering Operation of Boom

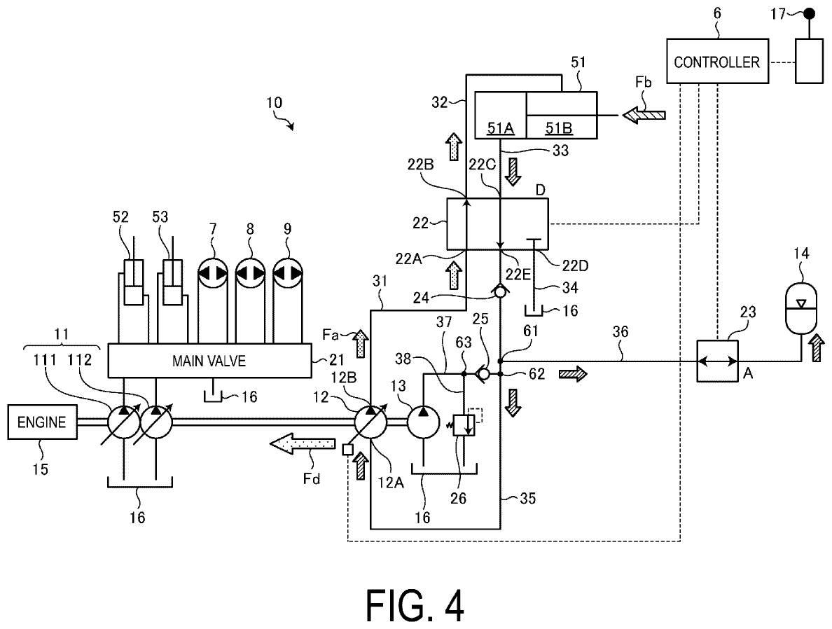

FIG. 4 is a view illustrating the hydraulic system 10 when causing the boom 41 according to the embodiment to perform a lowering operation. Note that in FIG. 4, arrow Fa indicates a direction in which the hydraulic oil flows, and arrow Fb indicates an expansion/contraction direction of the boom cylinder 51. The boom operation valve 22 illustrated in FIG. 4 is illustrated with a part of the boom operation valve 22 placed at the lowered position D extracted, and the accumulator switching valve 23 illustrated in FIG. 4 is illustrated with a part of the accumulator switching valve 23 placed at the fully open position A extracted.

In the lowering operation of the boom 41, the boom cylinder 51 contracts due to the weight of the boom 41, and the hydraulic oil is emitted from the bottom chamber 51A. In the lowering operation of the boom 41, the controller 6 controls the boom operation valve 22 and the accumulator switching valve 23 so that the hydraulic oil emitted from the bottom chamber 51A is distributed to the suction port 12A of the boom pump 12 and the accumulator 14. That is, when the operation lever 17 is operated for the boom 41 to perform a lowering operation, the controller 6 outputs a control command to the boom operation valve 22 so that the boom operation valve 22 is placed at the lowered position D based on an operation signal from operation lever 17. The controller 6 outputs a control command to the accumulator 14 so that the accumulator 14 is placed at the fully open position A.

Part of the hydraulic oil emitted from the bottom chamber 51A is supplied to the suction port 12A of the boom pump 12 via the bottom line 33, the bottom port 22C of the boom operation valve 22, the regenerative port 22E of the boom operation valve 22, and the regenerative line 35. The boom pump 12 is driven based on the hydraulic oil supplied to the suction port 12A. The boom pump 12 functions as a hydraulic motor in the lowering operation of the boom 41. As indicated by arrow Fd in FIG. 4, in the lowering operation of the boom 41, the rotational energy of the boom pump 12 is transmitted to the main hydraulic pump 11 as regenerative energy. The rotational energy of the boom pump 12 assists the rotation of the main hydraulic pump 11. The main hydraulic pump 11 is driven based on the rotational force of the engine 15 and the rotational force of the boom pump 12.

Part of the hydraulic oil emitted from the bottom chamber 51A is supplied to the accumulator 14 via the bottom line 33, the bottom port 22C of the boom operation valve 22, the regenerative port 22E of the boom operation valve 22, a part of the regenerative line 35, the connection portion 61, and the accumulator line 36. The accumulator 14 is pressurized with the hydraulic oil supplied from the bottom chamber 51A.

In the embodiment, the distribution ratio at which the hydraulic oil emitted from the bottom chamber 51A is distributed to the suction port 51A and the accumulator 14 in the lowering operation of the boom 41 is determined based on the cross-sectional area ratio between the bottom chamber 12A and the head chamber 51B.

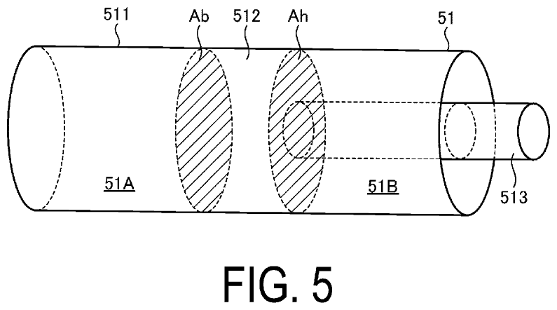

FIG. 5 is a view schematically illustrating the boom cylinder 51 according to the embodiment. As illustrated in FIG. 5, the boom cylinder 51 includes a cylinder tube 511, a piston 512, and a piston rod 513. The piston rod 513 is disposed at the head chamber 51B. Since the piston rod 513 is disposed at the head chamber 51B, a cross-sectional area Ab of the bottom chamber 51A is smaller than a cross-sectional area Ah of the head chamber 51B. In the embodiment, it is assumed that the cross-sectional area Ah of the head chamber 51B is ½ of the cross-sectional area of the bottom chamber 51A (Ab:Ah=2:1).

In order to suppress the head chamber 51B from having negative pressure when the boom cylinder 51 contracts in the lowering operation of the boom 41, the controller 6 determines the distribution ratio at which the hydraulic oil emitted from the bottom chamber 51A is distributed to the suction port 12A and the accumulator 14 based on the cross-sectional area ratio between the bottom chamber 51A and the head chamber 51B. In the embodiment, since the cross-sectional area ratio between the bottom chamber 51A and the head chamber 51B is [Ab:Ah=2:1], the controller 6 distributes the hydraulic oil emitted from the bottom chamber 51A to the suction port 12A and the accumulator 14 at a distribution ratio [1:1].

In FIG. 4, for example, when the flow rate of the hydraulic oil emitted from the bottom chamber 51A is 150 [L/min], the controller 6 controls the opening area of the accumulator switching valve 23 and the swash plate angle of the boom pump 12 so that the hydraulic oil is supplied to the suction port 12A at 75 [L/min] and the hydraulic oil is supplied to the accumulator 14 at 75 [L/min]. For example, when the accumulator switching valve 23 is placed at the fully open position A so that the opening area of the accumulator switching valve 23 becomes 100% in the lowering operation of the boom 41, the opening area of the boom operation valve 22 is adjusted in accordance with the opening area of the accumulator switching valve 23. Since the hydraulic oil is supplied to the suction port 12A at 75 [L/min], the hydraulic oil is supplied from the discharge port 12B to the head chamber 51B at 75 [L/min].

When the flow rate of the hydraulic oil emitted from the bottom chamber 51A is 150 [L/min], the flow rate of the hydraulic oil supplied to the head chamber 51B is adjusted to 75 [L/min] based on the cross-sectional area ratio between the bottom chamber 51A and the head chamber 51B, and therefore the head chamber 51B is suppressed from having negative pressure. Since the head chamber 51B is suppressed from having negative pressure, cavitation is suppressed from being generated at the head chamber 51B.

The controller 6 controls the swash plate angle of the boom pump 12 and the opening area of the accumulator switching valve 23 so that the ratio between a boom pump rotation speed indicating the rotation speed of the boom pump 12 and a boom cylinder speed indicating the expansion/contraction speed of the boom cylinder 51 becomes constant based on an engine rotation speed indicating the rotation speed of the engine 15 and the lever angle indicating the operation angle of the operation lever 17 in the lowering operation of the boom 41. The controller 6 controls the swash plate angle of the boom pump 12 and the opening area of the accumulator switching valve 23 so that the boom cylinder 51 operates at an intended boom cylinder speed based on the engine rotation speed and the lever angle. The engine rotation speed and the boom pump rotation speed match each other. The boom cylinder speed is proportional to the flow rate of the hydraulic oil discharged from the boom pump 12. The flow rate of the hydraulic oil discharged from the boom pump 12 matches the product of the boom pump rotation speed and the swash plate angle of the boom pump 12 (volume of the boom pump 12). In the embodiment, correlation data indicating the relationship among the engine rotation speed, the lever angle, the swash plate angle of the boom pump 12, and the opening area of the accumulator switching valve 23 for making the ratio between the boom pump rotation speed and the boom cylinder speed constant is obtained in advance and stored at the controller 6. The controller 6 controls the swash plate angle of the boom pump 12 and the opening area of accumulator switching valve 23 so that the ratio between the boom pump rotation speed and the boom cylinder speed becomes constant based on the engine rotation speed, the lever angle, and the correlation data.

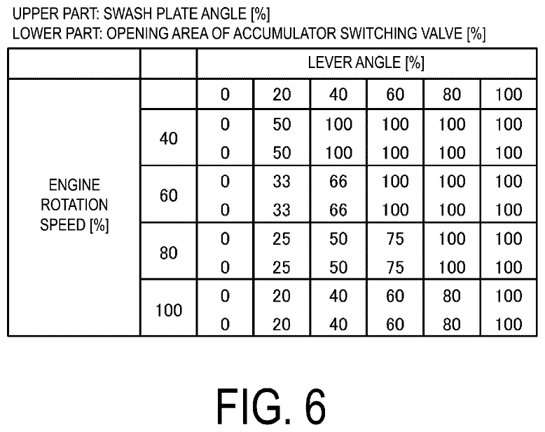

FIG. 6 is a view showing an example of correlation data according to the embodiment. As shown in FIG. 6, correlation data indicating the relationship among the proportion of the engine rotation speed when the highest value of the engine rotation speed is 100%, the proportion of the lever angle when the maximum value of the lever angle is 100%, the proportion of the swash plate angle when the maximum value of the swash plate angle of the boom pump 12 is 100%, and the proportion of the opening area of the accumulator switching valve 23 when the maximum value of the opening area of the accumulator switching valve 23 is 100% in order to make the ratio between the boom pump rotation speed and the boom cylinder speed constant is obtained in advance and stored at the controller 6. The correlation data can be obtained by a preliminary experiment or simulation.

FIG. 6 is a chart showing the relationship among the proportion of the engine rotation speed, the proportion of the lever angle, the proportion of the swash plate angle, and the proportion of the opening area of the accumulator switching valve. In the chart shown in FIG. 6, the vertical axis represents the proportion of the engine rotation speed, and the horizontal axis represents the proportion of the lever angle. In one cell, the numerical value described in the upper part is the proportion of the swash plate angle, and the numerical value described in the lower part is the proportion of the opening area of the accumulator switching valve.

The controller 6 determines the distribution ratio (flow rate) of the hydraulic oil to be distributed to the suction port 12A and the accumulator 14 based on the cross-sectional area ratio between the bottom chamber 51A and the head chamber 51B. The controller 6 controls the swash plate angle of the boom pump 12 and the opening area of the accumulator switching valve 23 based on the engine rotation speed, the lever angle, and the correlation data so that the ratio between the boom pump rotation speed and the boom cylinder speed becomes constant when the hydraulic oil having a determined flow rate is caused to flow into the suction port 12A. For example, when the engine 15 is provided with an engine rotation speed sensor, the controller 6 can monitor the engine rotation speed based on detection data of the engine rotation speed sensor. The controller 6 can monitor the lever angle based on an operation signal from the operation lever 17.

As described above, the engine 15, the main hydraulic pump 11, and the boom pump 12 are connected (directly coupled). In the lowering operation of the boom 41, each of the rotational force of the engine 15 and the rotational force of the boom pump 12 is transmitted to the main hydraulic pump 11. In the lowering operation of the boom 41, the swash plate angle of the boom pump 12 and the opening area of the accumulator switching valve 23 are controlled so that the ratio between the boom pump rotation speed and the boom cylinder speed becomes constant, whereby each of the engine 15, the main hydraulic pump 11, and the boom pump 12 can be smoothly driven.

### Raising Operation of Boom with Assist of Accumulator

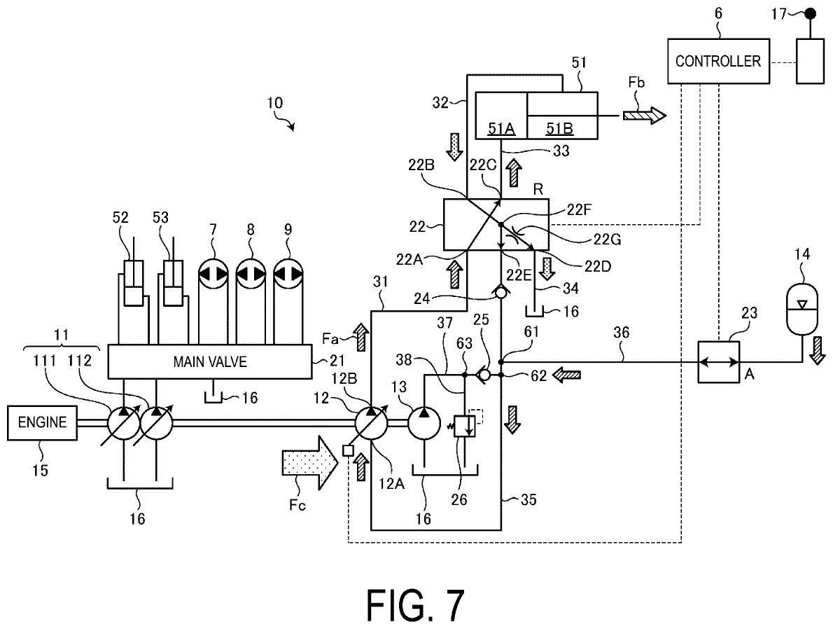

FIG. 7 is a view illustrating the hydraulic system 10 when causing the boom 41 to perform a raising operation by the hydraulic oil released from the accumulator 14 according to the embodiment. Note that in FIG. 7, arrow Fa indicates a direction in which the hydraulic oil flows, and arrow Fb indicates an expansion/contraction direction of the boom cylinder 51. The boom operation valve 22 illustrated in FIG. 7 is illustrated with a part of the boom operation valve 22 placed at the raised position R extracted, and the accumulator switching valve 23 illustrated in FIG. 7 is illustrated with a part of the accumulator switching valve 23 placed at the fully open position A extracted.

When the accumulator 14 is pressurized, the boom pump 12 is driven by the rotational force generated by the engine 15 and the pressure of the hydraulic oil released from the accumulator 14. The controller 6 controls the boom operation valve 22 and the accumulator switching valve 23 so that the hydraulic oil discharged from the discharge port 12B of the boom pump 12 is supplied to the bottom chamber 51A of the boom cylinder 51, and the hydraulic oil is supplied from the accumulator 14 to the suction port 12A of the boom pump 12, in the raising operation of the boom 41. That is, when the operation lever 17 is operated for the boom 41 to perform a raising operation, the controller 6 outputs a control command to the boom operation valve 22 so that the boom operation valve 22 is placed at the raised position R based on an operation signal from operation lever 17. The controller 6 outputs a control command to the accumulator 14 so that the accumulator 14 is placed at the fully open position A.

The hydraulic oil released from the accumulator 14 is supplied to the suction port 12A of the boom pump 12 via the accumulator line 36, the connection portion 61, and a part of the regenerative line 35. The suction port 12A is supplied with high-pressure hydraulic oil from the accumulator 14. As indicated by arrow Fc in FIG. 7, the rotational force generated by the engine 15 is transmitted to the boom pump 12 via the main hydraulic pump 11. The boom pump 12 discharges, from the discharge port 12B, the hydraulic oil sucked from the suction port 12A. The hydraulic oil discharged from the discharge port 12B is supplied to the bottom chamber 51A of the boom cylinder 51 via the pump line 31, the pump port 22A of the boom operation valve 22, the bottom port 22C of the boom operation valve 22, and the bottom line 33. When the bottom chamber 51A is supplied with the hydraulic oil, the boom cylinder 51 extends, and the boom 41 performs a raising operation.

The hydraulic oil emitted from the head chamber 51B is emitted to the hydraulic oil tank 16 via the head line 32, the head port 22B of the boom operation valve 22, the tank port 22D of the boom operation valve 22, and the tank line 34.

When the hydraulic oil is released from the accumulator 14, the pressure of the regenerative line 35 becomes higher due to the hydraulic oil released from the accumulator 14. The pressure of the hydraulic oil emitted from the head chamber 51B is lower than the pressure of the hydraulic oil released from the accumulator 14. Therefore, the hydraulic oil emitted from the head chamber 51B does not flow into the regenerative line 35 via the boom operation valve 22. For example, when the flow rate of the hydraulic oil released from the accumulator 14 is 150 [L/min], the flow rate of the hydraulic oil flowing from the accumulator 14 into the suction port 12A of the boom pump 12 is 150 [L/min], the flow rate of the hydraulic oil supplied from the discharge port 12B to the bottom chamber 51A is 150 [L/min], and the flow rate of the hydraulic oil emitted from the head chamber 51B is 75 [L/min], the entire hydraulic oil emitted from the head chamber 51B is discharged to the hydraulic oil tank 16.

### Effects

As described above, in the embodiment, the hydraulic excavator 1 includes the boom 41, the boom cylinder 51 including the bottom chamber 51A and the head chamber 51B, the boom pump 12 including the suction port 12A and the discharge port 12B, the boom operation valve 22 including the pump port 22A connected to the discharge port 12B via the pump line 31, the bottom port 22C connected to the bottom chamber 51A via the bottom line 33, the head port 22B connected to the head chamber 51B via the head line 32, and the regenerative port 22E connected to the suction port 12A via the regenerative line 35, the accumulator 14 connected to the regenerative line 35 via the accumulator line 36, the accumulator switching valve 23 that adjusts the flow rate of the hydraulic oil in the accumulator line 36, and the controller 6 that controls the boom operation valve 22 and the accumulator switching valve 23 so that the hydraulic oil emitted from the bottom chamber 51A is distributed to each of the suction port 12A and the accumulator 14 in the lowering operation of the boom 41.

According to the embodiment, the hydraulic oil emitted from the boom cylinder 51 in the lowering operation of the boom 41 is supplied to the accumulator 14 before flowing into the suction port 12A of the boom pump 12. Since the hydraulic oil for pressurizing the accumulator 14 does not pass through the boom pump 12, the accumulator 14 is efficiently pressurized.

Part of the hydraulic oil emitted from the boom cylinder 51 is returned to the boom pump 12. Since the entire hydraulic oil emitted from the boom cylinder 51 is not returned to the boom pump 12, it is not necessary to unnecessarily increase the pump capacity of the boom pump 12. Therefore, an increase in size of the boom pump 12 is suppressed.

The controller 6 controls the boom operation valve 22 and the accumulator switching valve 23 so that the hydraulic oil discharged from the discharge port 12B is supplied to the bottom chamber 51A and the hydraulic oil is supplied from the accumulator 14 to the suction port 12A in the raising operation of the boom 41. The hydraulic oil pressurized at the accumulator 14 assists the drive of the boom pump 12 in the raising operation of the boom 41. The accumulator 14 and the suction port 12A are connected via the accumulator line 36 and the regenerative line 35. Therefore, even if the pressure acting on the suction port 12A from the accumulator 14 is not excessively large, the accumulator 14 can assist the drive of the boom pump 12. In the raising operation of the boom 41, since both the rotational force generated by the engine 15 and the pressure of the hydraulic oil released from the accumulator 14 are input to the boom pump 12, the boom pump 12 can be driven even if the rotational force of the engine 15 is small, and thus the fuel consumption amount of the engine 15 is reduced.

The distribution ratio at which the hydraulic oil emitted from the bottom chamber 51A is distributed to the suction port 12A and the accumulator 14 in the lowering operation of the boom 41 is determined based on the cross-sectional area ratio between the bottom chamber 51A and the head chamber 51B. This suppresses the head chamber 51B from having negative pressure in the lowering operation of the boom 41. Since the bottom chamber 51A is suppressed from having negative pressure, cavitation is suppressed from being generated at the bottom chamber 51A.

In the lowering operation of the boom 41, the rotational energy of the boom pump 12 is transmitted to the main hydraulic pump 11. By this, the rotational energy of the boom pump 12 generated in the lowering operation of the boom 41 is effectively used as regenerative energy.

In the lowering operation of the boom 41, after determining the flow rate of the hydraulic oil caused to flow into the suction port 12A based on the cross-sectional area ratio between the bottom chamber 51A and the head chamber 51B, the controller 6 controls the swash plate angle of the boom pump 12 and the opening area of the accumulator switching valve 23 so that the ratio between the rotation speed of the boom pump 12 and the boom cylinder speed indicating the expansion/contraction speed of the boom cylinder 51 becomes constant based on the determined flow rate, the engine rotation speed, and the lever angle. In the lowering operation of the boom 41, since the ratio between the rotation speed of the boom pump 12 and the boom cylinder speed becomes constant, each of the engine 15, the main hydraulic pump 11, and the boom pump 12 can be smoothly driven.

### REFERENCE SIGNS LIST

1 Hydraulic excavator (work machine), 2 Traveling body, 2A Continuous track, 3 Revolving body, 4 Work implement, 5 Work implement cylinder, 6 Controller, 7 Traveling motor (main hydraulic actuator), 8 Traveling motor (main hydraulic actuator), 9 Revolving motor (main hydraulic actuator), 10 Hydraulic system, 11 Main hydraulic pump, 12 Boom pump, 12A Suction port, 12B Discharge port, 13 Charge pump, 14 Accumulator, 15 Engine, 16 Hydraulic oil tank, 17 Operation lever, 21 Main valve, 22 Boom operation valve, 22A Pump port, 22B Head port, 22C Bottom port, 22D Tank port, 22E Regenerative port, 22F Branch portion, 22G Throttle, 23 Accumulator switching valve, 24 First check valve, 25 Second check valve, 26 Relief valve, 31 Pump line, 32 Head line, 33 Bottom line, 34 Tank line, 35 Regenerative line, 36 Accumulator line, 37 Charge line, 38 Relief line, 41 Boom, 42 Arm, 43 Bucket, 51 Boom cylinder, 51A Bottom chamber, 51B Head chamber, 52 Arm cylinder (main hydraulic actuator), 53 Bucket cylinder (main hydraulic actuator), 61 Connection portion, 62 Connection portion, 63 Connection portion, 111 Main hydraulic pump, 112 Main hydraulic pump, 511 Cylinder tube, 512 Piston, 513 Piston rod, A Fully open position, B Fully closed position, D Lowered position, N Neutral position, R Raised position.

1. A work machine comprising:
a boom;
a boom cylinder 51 including a bottom chamber and a head chamber;
a boom pump 12 including a suction port and a discharge port;
a hydraulic oil tank;
a boom operation valve including a pump port connected to the discharge port via a pump line, a bottom port connected to the bottom chamber via a bottom line, a head port connected to the head chamber via a head line, a tank port connected to the hydraulic oil tank via a tank line, and a regenerative port connected to the suction port via a regenerative line;
an accumulator connected to the regenerative line via an accumulator line;
an accumulator switching valve that adjusts a flow rate of hydraulic oil in the accumulator line; and
a controller that controls the boom operation valve and the accumulator switching valve so that hydraulic oil emitted from the bottom chamber is distributed to each of the suction port and the accumulator in a lowering operation of the boom.

2. The work machine according to claim 1, wherein
the controller controls the boom operation valve and the accumulator switching valve so that hydraulic oil discharged from the discharge port is supplied to the bottom chamber and hydraulic oil is supplied from the accumulator to the suction port in a raising operation of the boom.

3. The work machine according to claim 1, wherein
a distribution ratio at which hydraulic oil emitted from the bottom chamber is distributed to the suction port and the accumulator in a lowering operation of the boom is determined based on a cross-sectional area ratio between the bottom chamber and the head chamber.

4. The work machine according to claim 1, comprising:
a main hydraulic actuator; and
a main hydraulic pump that is connected to the boom pump and discharges hydraulic oil for actuating the main hydraulic actuator, wherein
in a lowering operation of the boom, a rotational energy of the boom pump is transmitted to the main hydraulic pump.

5. The work machine according to claim 4, wherein
the boom pump is a variable capacity hydraulic pump whose pump capacity changes based on a swash plate angle, and includes
an engine for driving each of the main hydraulic pump and the boom pump, and
an operation lever to be operated to actuate the boom operation valve, and
the controller controls a swash plate angle of the boom pump and an opening area of the accumulator switching valve so that a ratio between a rotation speed of the boom pump and an expansion/contraction speed of the boom cylinder becomes constant based on an engine rotation speed indicating a rotation speed of the engine and a lever angle indicating an operation angle of the operation lever in a lowering operation of the boom.
